(19) United States
(12) Patent Application Publication
(10) Pub. No.: US 2007/0242711 A1
(43) Pub. Date: Oct. 18, 2007

(54) Compensation for dynamic thermal effects in fast tunable lasers

(75) Inventors: Uri Griner, San Francisco, CA (US); Ralph Theodore Hofmeister, Los Altos, CA (US); Oren Moshe, San Francisco, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Matisse Networks

(21) Appl. No.: 11/730,336

(22) Filed: Mar. 30, 2007

Related U.S. Application Data
(60) Provisional application No. 60/787,226, filed on Mar. 30, 2006.

(51) Int. Cl. H01S 3/04

(52) U.S. Cl. 372/34

(57) ABSTRACT

Methods, systems, and apparatuses for the compensation of dynamic thermal effects in fast tunable lasers are related in the present application. In particular, certain embodiments of the present invention may be useful for controlling currents to achieve various current-controlled characteristics in fast tunable lasers. Thus, certain systems, methods, and apparatuses described herein may provide compensation of dynamic thermal effects in fast tunable lasers.

### CROSS REFERENCE TO RELATED APPLICATIONS

This application is related to and claims the priority of U.S. Provisional Patent Application No. 60/787,226, filed Mar. 30, 2006, the entire disclosure of which is hereby incorporated by reference.

### BACKGROUND OF THE INVENTION

1. Field of the Invention

The present invention generally relates methods, systems, and apparatuses for the compensation of dynamic thermal effects in fast tunable lasers. In particular, certain embodiments of the present invention may be useful for controlling currents to achieve various current-controlled characteristics in fast tunable lasers. Thus, certain systems, methods, and apparatuses described herein may provide compensation of dynamic thermal effects in fast tunable lasers.

2. Description of the Related Art

Typically, Fast Tunable Lasers (FTL), are implemented using various current controlled modules or sections. The modules can include mirrors, as well as modules for Phase, Gain, and amplification. Currents can determine the laser output in terms of wavelength, power, and other optical characteristics such as Optical Signal Noise Ratio (OSNR), Side-Mode Suppression Ratio (SMSR) and the like. A characterization process is usually performed on each FTL to find a set of steady state currents for each steady state channel. However, when switching channels at high speed (<2 seconds), there can be a dynamic thermal effect in each section that causes the laser output characteristics to deviate from the steady state characteristics. Therefore, to switch fast and accurately to a specific channel, there is a need to compensate for these local temperature changes.

### SUMMARY OF THE INVENTION

One embodiment of the present invention can be a method for compensation of dynamic thermal effects in a fast tunable laser. The method can include providing a fast tunable laser in an initial point, wherein the initial point is at a first steady state with respect to dynamic thermal effects. The method can also include identifying a first target value for a parameter of the fast tunable laser. The method can further include setting a current of the fast tunable laser based on the first target value. The method can additionally include, before a second state is reached, identifying a second target value for the parameter, calculating a point on an effective temperature curve, calculating a difference between a present current on the effective temperature curve and the second target value, and applying a correction to the current settings.

Another embodiment of the present invention can be a system for compensation of dynamic thermal effects in a fast tunable laser. The system can include provision means for providing a fast tunable laser in an initial point, wherein the initial point is at a first steady state with respect to dynamic thermal effects. The system can also include identification means for identifying a first target value for a parameter of the fast tunable laser. The system can further include setting means for setting a current of the fast tunable laser based on the first target value. The system can additionally include correction means for, before a second state is reached, identifying a second target value for the parameter, calculating a point on an effective temperature curve, calculating a difference between a present current on the effective temperature curve and the second target value, and applying a correction to the current settings.

A further embodiment of the present invention can be an apparatus for compensation of dynamic thermal effects in a fast tunable laser. The apparatus can include a initiation unit configured to provide a fast tunable laser in an initial point, wherein the initial point is at a first steady state with respect to dynamic thermal effects. The apparatus can also include an identification unit configured to identify a first target value for a parameter of the fast tunable laser. The apparatus can further include a setting unit configured to set a current of the fast tunable laser based on the first target value. The apparatus can additionally include a correction unit configured to, before a second state is reached, identify a second target value for the parameter, calculate a point on an effective temperature curve, calculate a difference between a present current on the effective temperature curve and the second target value, and apply a correction to the current settings.

### BRIEF DESCRIPTION OF THE DRAWINGS

For proper understanding of the invention, reference should be made to the accompanying drawings, wherein:

FIG. 1 illustrates an example of thermal effect and its compensation.

FIG. 2 illustrates an effective temperature function as samples in the time domain.

FIG. 3 illustrates an example algorithm for temperature correction for any of the FTL sections.

### DETAILED DESCRIPTION OF THE PREFERRED EMBODIMENT(S)

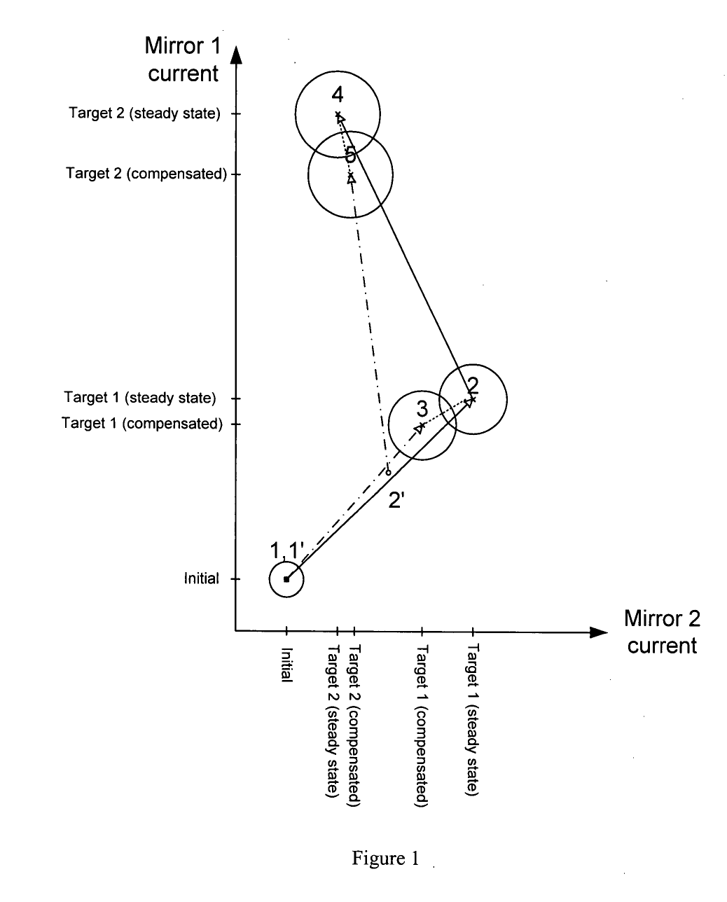

An example of thermal effect and its compensation are provided in FIG. 1. To simplify the example, the figure illustrates a switch that requires change of only the two mirrors currents. The present invention, however, is not limited to this example. Because only the two mirror currents are being considered, thermal compensation is only discussed on those two currents. In the example, a switch is made from a steady state channel with low mirrors currents to a channel with high currents.

The steady state currents of the first channel can be seen at an initial point (“initial”), which is in the center of mode 1, circle 1. The steady state currents of the second channel may be the first target point (“Target 1 (steady state)”) in the center of Mode 2. However, due to the dynamic thermal effect, the actual position of the target point right after switching is point 3 (“Target 1 (compensated)”). Then, the actual position of the target point can drift gradually with time toward the point in the center of circle 2, the steady state position.

The position of the target point can be followed by changing the mirrors currents fast enough. Usually these currents are changing on the time scale of nanoseconds. On the other hand, the actual temperature (or equivalent temperature) in each one of the FTL sections is converging to its steady state relatively slowly in time and will reach the Steady State value in a matter of seconds.

In a system that does not allow for complete convergence to the steady state value before switching to the next wavelength, there can be a need to know the equivalent current at the new initial point and the currents at the new steady state position.

To understand this point further, refer again to the example shown in FIG. 1. After a first switch has been made to the first target the point in the center of circle 2, the actual currents injected to the FTL mirrors are moving from 3 to 2. At the same time the equivalent currents in those sections are moving from 1 toward the mirrors actual currents. In order to switch accurately to the next target wavelength, it may be necessary to know the effective currents of the mirrors just before the next switch.

Then, according to the equivalent current, which is the new initial point (2′), and the new target point, the center of circle 4, one can calculate the new target compensated point (the center of circle 5), and so on for additional changes in target point.

A system environment to implement the temperature correction can include a processing unit or a Field-Programmable Gate Array (FPGA) as well as a Digital-to-Analog Converter (DAC) on which the values calculated by the FPGA are converted into currents to be applied to the FTL.

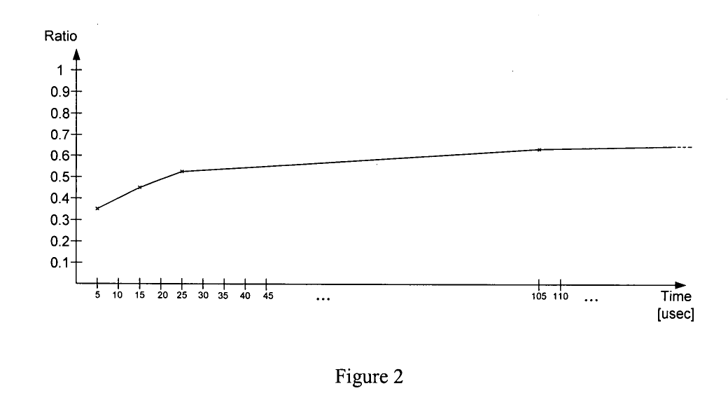

In the FTL characterization process a map of all target wavelengths the FTL can reach in terms of sections currents can be determined. These wavelengths are all steady state wavelengths, thus, the set of sections currents at these points are valid for steady state transaction only. The first FTL position can, for example, always be a steady state position. This can be achieved in practice by letting the FTL settle during startup. After the first switch command, the target wavelength set of currents can then depend on how long the FTL rested in a certain point. If the FTL rested more than few second it will reach a temperature steady state point that is equal to one found in the characterization. Otherwise, the FTL will be on a certain point on a curve, as illustrated, for example, in FIG. 2.

Determining the location of the FTL on the curve can be important in calculating the correction needed to reach the target Wavelength accurately. Thus, care can be taken in making the determination as to where on the curve the FTL is.

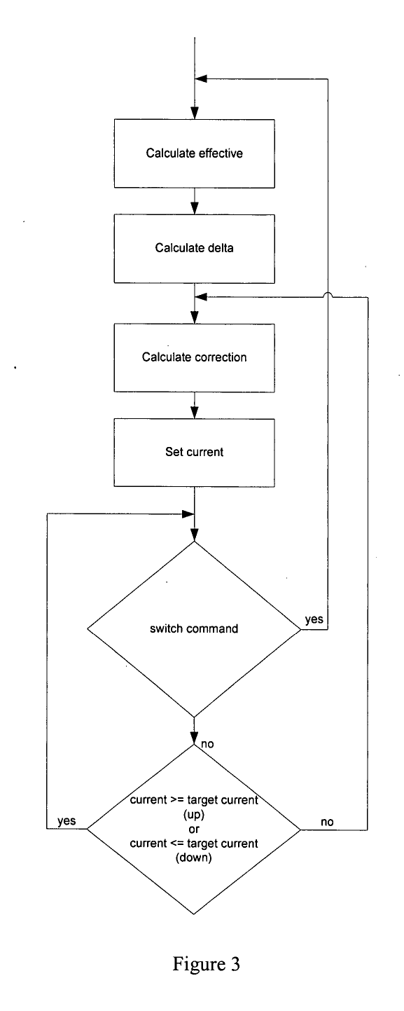

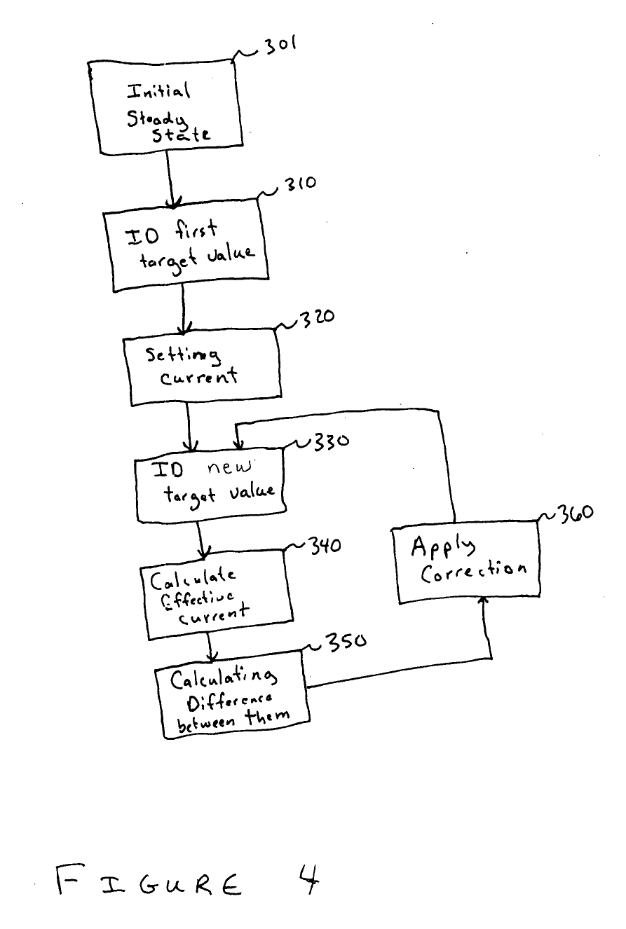

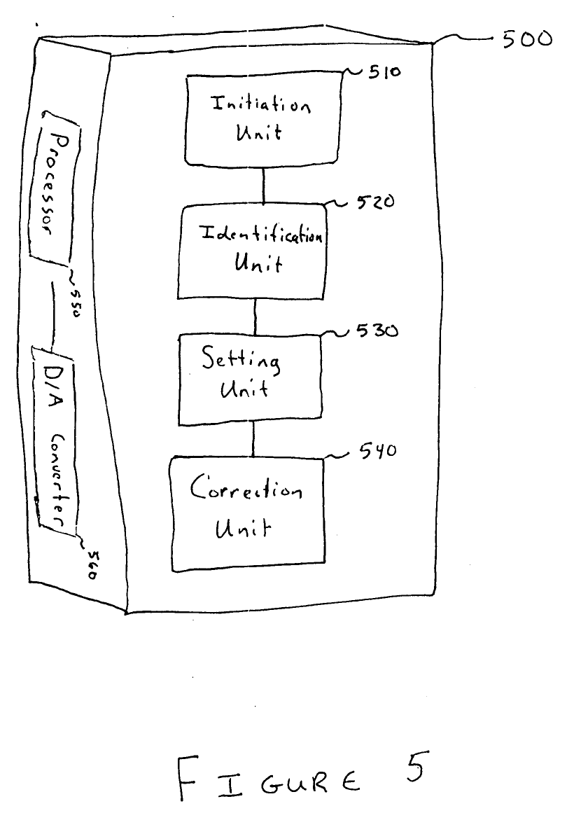

The basic algorithm for the temperature correction algorithm for any of the FTL sections is illustrated, for example, in FIG. 3. According to this algorithm, just before each switch command to the FTL, the FTL controller can calculate the effective currents based on the actual temperature of the sections at the time of switching. Then the FTL controller can calculate a change (delta) in currents from the target, and translate that delta to a time varying current correction. The current correction can be added to the effective current continuously until either the current reaches the target or a new switch command is initiated.

The temperature dynamics can act differently on each section while cooling as compared to heating. Therefore, to calculate the effective currents, the FTL controller can be provided with two different functions for each section (one function dealing with a switch to high and the other function dealing with a switch to low). The shape of these functions can be the combination of several exponential functions.

Therefore, for practical reasons and to reduce the complexity of calculations, the effective currents function can be approximated by breaking it into a piecewise-linear equation. The equation for those lines can be given by, for example:
Effective(i,k)=initial+(target−initial)×[ratio(i)+slope(i)×(k−1)]

where ratio(i) is a fraction with values between 0 and 1, the slope(i) is also a fraction with values between 0 and 1, i is the line number, and k is the correction number in that line that occurs every predefined period of time. The initial value is the last effective temperature calculated before the last switch event.

After calculating the effective currents, calculation of the distance between the target current and the initial current (the effective current) can be performed. This equation can be given as:
delta=target−effective

As in the effective currents calculation case, the temperature dynamics can act differently on each section, depending on whether the FTL is cooling or heating. Therefore, to calculate the effective currents, two different functions for each section (switch to high and switch to low) can be provided. These functions shape is the combination of several exponential functions. Thus, a piecewise-linear equation can be convenient to express the relationship:
Corrected(i,k)=effective+(target−effective)×[ratio(i,target)+slope(i,target)×(k−1)]

where ratio(i,target) is a fraction with values between 0 and 1, the slope(i, target) is also a fraction with values between 0 and 1, both ratio (i) and slope (i) are target dependent, i is the line number, k is the correction number in that line that occurs every predefined period of time, and the effective value is the effective temperature calculated before the last switch event.

FIG. 4 illustrates a block diagram of a method according to an example embodiment of the present invention. The illustrated in FIG. 4 can be a method for compensation of dynamic thermal effects in a fast tunable laser. The method can include providing 301 a fast tunable laser in an initial point, wherein the initial point is at a first steady state with respect to dynamic thermal effects. This provision 301 of the fast tunable laser in the initial point can be performed by allowing the fast tunable laser to settle during startup

The method can also include identifying 310 a first target value for a parameter of the fast tunable laser. The parameter includes at least one of a mirror, phase, gain, or amplification.

The method can further include setting 320 a current of the fast tunable laser based on the first target value. The setting the current can be configured to achieve at least one characteristic for the fast tunable laser selected from wavelength, power, optical signal to noise ratio, or side-mode suppression ratio.

Before a second state is reached (which can be a period of, for example, less than two seconds), the method can include identifying 330 a second target value for the parameter, calculating 340 a point on an effective temperature curve, calculating 350 a difference between a present current on the effective temperature curve and the second target value, and applying 360 a correction to the current settings. The effective temperature curve can be a piecewise linear approximation.

As illustrated in FIG. 4, third and subsequent target values can be accommodated by looping back to the identification 330 of a new target value and so forth. Furthermore, two currents can be simultaneously controlled using the method, as illustrated, for example, in FIG. 1.

FIG. 5 illustrates an apparatus 500 for compensation of dynamic thermal effects in a fast tunable laser. The apparatus 500 can include an initiation unit 510 configured to provide a fast tunable laser in an initial point, wherein the initial point is at a first steady state with respect to dynamic thermal effects.

The apparatus 500 can also include an identification 520 unit configured to identify a first target value for a parameter of the fast tunable laser. The parameter can include at least one of a mirror, phase, gain, or amplification.

The apparatus 500 can further include a setting unit 530 configured to set a current of the fast tunable laser based on the first target value. The setting unit can be configured to set the current is configured to achieve at least one characteristic for the fast tunable laser selected from wavelength, power, optical signal to noise ratio, or side-mode suppression ratio.

The apparatus 500 can additionally include a correction unit 540 configured to, before a second state is reached (which can be, for example, less than about two seconds), identify a second target value for the parameter, calculate a point on an effective temperature curve, calculate a difference between a present current on the effective temperature curve and the second target value, and apply a correction to the current settings. The effective temperature curve can be a piecewise linear approximation.

The apparatus 500 can be configured to control two currents simultaneously.

The apparatus 500 is shown in terms of the initiation unit 510, identification unit 520, setting unit 530, and correction unit 540 in a front panel and in terms of a processor 550 or a field-programmable gate array, as well as a digital-to-analog (D/A) converter 560 configured to convert values from the processor 550 or the field programmable gate array into the currents for the fast tunable laser. Thus, the front and side panels may complimentary way of looking at the apparatus 500, and the processor 550 and D/A converter 560 may provide physical implementation of the initiation unit 510, identification unit 520, setting unit 530, and correction unit 540.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method for compensation of dynamic thermal effects in a fast tunable laser, the method comprising:
providing a fast tunable laser in an initial point, wherein the initial point is at a first steady state with respect to dynamic thermal effects;
identifying a first target value for a parameter of the fast tunable laser;
setting a current of the fast tunable laser based on the first target value; and
before a second state is reached,
identifying a second target value for the parameter,
calculating a point on an effective temperature curve,
calculating a difference between a present current on the effective temperature curve and the second target value, and
applying a correction to the current settings.

2. The method of claim 1, wherein the parameter comprises at least one of a mirror, phase, gain, or amplification.

3. The method of claim 1, wherein the effective temperature curve is a piecewise linear approximation.

4. The method of claim 1, wherein the setting the current comprises achieving at least one characteristic for the fast tunable laser selected from wavelength, power, optical signal to noise ratio, or side-mode suppression ratio.

5. The method of claim 1, wherein a time before the second state is reached comprises a period of less than two seconds.

6. The method of claim 1, wherein two currents are simultaneously controlled using the method.

7. The method of claim 1, wherein the providing the fast tunable laser in the initial point comprises allowing the fast tunable laser to settle during startup.

8. A system for compensation of dynamic thermal effects in a fast tunable laser, the system comprising:
provision means for providing a fast tunable laser in an initial point, wherein the initial point is at a first steady state with respect to dynamic thermal effects;
identification means for identifying a first target value for a parameter of the fast tunable laser;
setting means for setting a current of the fast tunable laser based on the first target value;
correction means for, before a second state is reached,
identifying a second target value for the parameter,
calculating a point on an effective temperature curve,
calculating a difference between a present current on the effective temperature curve and the second target value, and
applying a correction to the current settings.

9. The system of claim 8, wherein the parameter comprises at least one of a mirror, phase, gain, or amplification.

10. The system of claim 8, wherein the effective temperature curve is a piecewise linear approximation.

11. The system of claim 8, wherein the setting means for setting the current is configured to achieve at least one characteristic for the fast tunable laser selected from wavelength, power, optical signal to noise ratio, or side-mode suppression ratio.

12. The system of claim 8, wherein a time before the second state is reached comprises a period of less than two seconds.

13. The system of claim 8, wherein the system is configured to control two currents simultaneously.

14. An apparatus for compensation of dynamic thermal effects in a fast tunable laser, the apparatus comprising:
a initiation unit configured to provide a fast tunable laser in an initial point, wherein the initial point is at a first steady state with respect to dynamic thermal effects;
an identification unit configured to identify a first target value for a parameter of the fast tunable laser;
a setting unit configured to set a current of the fast tunable laser based on the first target value;
a correction unit configured to, before a second state is reached,
identify a second target value for the parameter,
calculate a point on an effective temperature curve,
calculate a difference between a present current on the effective temperature curve and the second target value, and
apply a correction to the current settings.

15. The apparatus of claim 14, wherein the parameter comprises at least one of a mirror, phase, gain, or amplification.

16. The apparatus of claim 14, wherein the effective temperature curve is a piecewise linear approximation.

17. The apparatus of claim 14, wherein the setting unit configured to set the current is configured to achieve at least one characteristic for the fast tunable laser selected from wavelength, power, optical signal to noise ratio, or side-mode suppression ratio.

18. The apparatus of claim 14, wherein a time before the second state is reached comprises a period of less than two seconds.

19. The apparatus of claim 14, wherein the apparatus is configured to control two currents simultaneously.

20. The apparatus of claim 14, wherein the initiation unit, identification unit, setting unit, and correction unit are implemented by a processing unit or a field-programmable gate array, as well as a digital-to-analog converter configured to convert values from the processing unit or the field programmable gate array into the currents for the fast tunable laser.
